(19) United States
(12) Patent Application Publication
(10) Pub. No.: US 2026/0307378 A1
(43) Pub. Date: Oct. 8, 2026

(54) COHESIVELY BONDED, MICROPOROUS MULTILAYER FILMS

(71) Applicant: Amtek Research International LLC, Lebanon, OR (US)

(72) Inventors: Richard W. Pekala, Corvallis, OR (US); Don Spitz, Albany, OR (US); Weston Wood, Lebanon, OR (US); Matt Warren, Salem, OR (US); Doug Atkinson, Lebanon, OR (US); John Norris, Lebanon, OR (US); Chi La, Happy Valley, OR (US)

(21) Appl. No.: 19/480,747

(22) PCT Filed: May 3, 2024
(86) PCT No.: PCT/US2024/027861

§ 371 Date: Oct. 31, 2025

Related U.S. Application Data
(60) Provisional application No. 63/500,531, filed on May 5, 2023.

(51) Int. Cl. B32B 27/32; B32B 7/12; B32B 27/08; H01M 50/417; H01M 50/446; H01M 50/457

(52) U.S. Cl. CPC B32B 27/32; B32B 7/12; B32B 27/08; H01M 50/417; H01M 50/446; H01M 50/457; B32B 2250/03; B32B 2250/242; B32B 2264/10; B32B 2305/026

(57) ABSTRACT

A multilayer microporous polyolefin film in which at least one layer is highly filled with inorganic particles such that the film exhibits good in-plane dimensional stability (i.e., low shrinkage) at temperatures both above and below the melting point of the polymer matrix is disclosed herein. A second extruded polyolefin layer is chosen such that its porosity and the overall permeability of the multilayer film will decrease above the melting point of the polymer matrix. The layers of the multilayer film are cohesively bonded and such films can be used as separators to improve the manufacturability, performance, and safety of energy storage devices such as lithium-ion batteries.

### RELATED APPLICATIONS

This application claims priority to U.S. Provisional Patent Application No 63/500,531, filed on May 5, 2023, and titled COHESIVELY BONDED, MICROPOROUS MULTILAYER FILMS, which is incorporated herein by reference in its entirety.

### TECHNICAL FIELD

The present invention relates to the formation of a multilayer microporous polyolefin film in which at least one layer includes a polymer matrix that is highly filled with inorganic particles such that the film exhibits good in-plane dimensional stability (i.e. low shrinkage) at temperatures both above and below the melting point of the polymer matrix. A second extruded polyolefin layer can be chosen such that a porosity of the second layer and the overall permeability of the multilayer film will decrease above the melting point of the polymer matrix of either the first or second layer. In other words, the extruded multilayer film is designed to minimize in-plane shrinkage while decreasing permeability in the thru-plane axis as the melting point of the polymer matrix is exceeded. Such films can be used as separators to improve the manufacturability, performance, and safety of energy storage devices such as lithium-ion batteries.

### BACKGROUND OF THE INVENTION

Separators are an integral part of the performance, safety, and cost of lithium-ion batteries. During normal operation, the principal functions of the separator are to prevent electronic conduction (i.e., shorts or direct contact) between the anode and cathode while permitting ionic conduction via the electrolyte. Under abuse conditions, such as external short circuit or overcharge, the separator is required to shutdown at temperatures well below where thermal runaway can occur. Shutdown results from the collapse of pores in the separator due to melting and viscous flow of the polymer, thus slowing down or stopping ion flow between the electrodes. Nearly all Li-ion battery separators contain polyethylene as part of a single- or multi-layer construction so that shutdown begins at ~130° C., the melting point of polyethylene.

Separators for the lithium-ion market are presently manufactured via “dry” or “wet” processes. In the dry process, a polymer such as polypropylene (PP) or polyethylene (PE) is extruded into a thin sheet and subjected to rapid drawdown. The sheet is then annealed at 10-25° C. below the polymer melting point such that crystallite size and orientation are controlled. Next, the sheet is rapidly stretched in the machine direction (MD) to achieve slit-like pores or voids. Trilayer PP/PE/PP separators produced by the dry process are commonly used in lithium-ion rechargeable batteries.

Wet process separators composed of high molecular weight polyethylene are produced by extrusion of an oil/polymer mixture at elevated temperature, followed by phase separation, biaxial stretching, and extraction of the process oil (i.e., plasticizer). The resultant separators have elliptical or spherical pores with good mechanical properties in both the machine and transverse directions. PE-based separators manufactured this way using cast film or blown film technologies have found wide use in Li-ion batteries.

More recently, battery failures in the field have demonstrated that shutdown is not a guarantee of safety. The principle reason is that, after shutting down, residual stress and reduced mechanical properties above the polymer melting point can lead to shrinkage, tearing, or pinhole formation. The exposed electrodes can then touch and create an internal short circuit that leads to more heating, thermal runaway and explosion.

In the case of large format Li-ion cells designed for hybrid, plug-in hybrid or electric vehicle applications (HEV, PHEV, EV), the benefits of separator shutdown have been openly questioned because it is difficult to guarantee a sufficient rate and uniformity of shutdown throughout the complete cell. As such, battery designers are expected to handle failure modes that might involve separator shutdown at the system level. For example, external short circuits can be prevented by mechanical design and location within the vehicle. Overcharge, over discharge, and high rate discharge are controlled by the Battery Management System (BMS). Thermal protection will also be handled on a system level, with active and/or passive cooling built in. Another consideration is that these batteries will be assembled as high voltage stacks where the shutdown of a single cell can itself create problems if, for instance, the shutdown cell is driven into voltage reversal by the other cells in a series string.

As such, many companies are focused on modifying the construction of a lithium-ion battery to include (1) a heat-resistant separator or (2) a heat-resistant layer coated on either the electrodes or a conventional polyolefin separator. Heat-resistant separators composed of high temperature polymers (e.g., aromatic polyamides) have been produced on a limited basis from solution casting, electrospinning, or other process technologies. In these cases, the high polymer melting point prevents shutdown at temperatures below 200° C.

In U.S. Pat. No. 7,638,230 B2, a porous heat resistant layer was coated onto the negative electrode. The heat resistant layer was composed of an inorganic filler and a polymer binder. Inorganic fillers included magnesia, titantia, zirconia, or silica. Polymer binders included polyvinylidene fluoride and a modified rubber mixture containing acrylonitrile units. The heat resistant layer comprised 1-5 parts binder for every 100 parts inorganic filler by weight. Higher binder contents negatively impacted the high rate discharge characteristics of the battery. Furthermore, the thickness of the porous heat-resistant layer had to be limited to 1-10 um to achieve high discharge rates.

In U.S. Pat. Nos. 7,638,241 B2 and 7,662,517 B2, an organic/inorganic separator is disclosed in which a porous substrate is coated with a mixture of inorganic particles and a polymer binder to form an active layer on at least one surface of the porous substrate. The porous substrate can be either a non-woven fabric, membrane, or a polyolefin-based separator. Inorganic particles are selected from a group consisting of those that exhibit dielectric constant greater than 5, piezoelectricity, and/or lithium ion conductivity. A variety of polymer binders are described. The composite separator is claimed to show excellent thermal safety, dimensional stability, electrochemical safety and lithium ion conductivity, and a high degree of swelling with electrolyte, compared to uncoated polyolefin-based separators used in Li-ion batteries.

Evonik (Dresden, Germany) has produced heat-resistant separators by coating a porous ceramic layer on each side of a polyester nonwoven using an inorganic binder sol. While having excellent thermal stability, the membranes had extremely low mechanical integrity (e.g., tensile strain <10%) which can create problems during battery assembly The inorganic particles were also found to easily shed from the separator surface.

In each of the above approaches, it is the inorganic-filled layer that is applied in a secondary coating operation onto an electrode or porous substrate to provide heat resistance and prevent internal shorts in the battery under high temperature, abuse conditions. The inorganic filled layer is applied as a coating that is adhesively bonded to the substrate because the described compositions do not provide sufficient mechanical integrity to form a freestanding, porous sheet or film. Freestanding refers to a sheet having sufficient mechanical properties that manipulation such as winding and unwinding in film can be used during energy storage device assembly.

In U.S. Pat. No. 9,896,555 B2, a freestanding, microporous, ultrahigh molecular weight polyethylene (UHMWPE)-based film that contained sufficient inorganic particles to provide low shrinkage while maintaining high porosity at temperatures above the melting point of the polymer matrix (>135° C.) was described. Such freestanding, heat resistant films could be used to prevent internal shorts in energy storage devices such as lithium-ion batteries; however, they did not exhibit shutdown capability in which the thru-plane permeability of the separator was decreased above the melting point of the polyethylene.

Heretofore, no consideration has been given to a cost-effective manufacturing process, material composition, and structure that can simultaneously result in a polyolefin separator that combines high temperature dimensional stability with thru-plane shutdown capabilities. In this disclosure, battery separators are formed from the co-extrusion or lamination of multiple layers to achieve the above objective.

### SUMMARY OF THE DISCLOSURE

An object of the present disclosure is to achieve thin, freestanding, multilayer microporous polyolefin films with good heat resistance and dimensional stability as provided through an inorganic-filled layer while simultaneously achieving thru-plane shutdown characteristics in a second layer. The term “freestanding” refers to a film having sufficient mechanical properties that permit manipulation such as winding and unwinding in film form during use in an energy storage device assembly. The term “film” is inclusive of other terms used in the scientific and patent literature such as “membrane”, “sheet”, and “web” and can be used interchangeably with such terms throughout this document. The term “microporous” refers to an average pore size less than about 1 micrometer (e.g., 0.1 to 0.3 microns as measured by mercury porosimetry).

In some embodiments, the inorganic-filled first layer (A layer) comprises ultrahigh molecular weight polyethylene (UHMWPE), extra high molecular weight polyethylene (EHMWPE), or combinations thereof. The repeat unit of polyethylene is (—CH₂CH₂—)ₓ, where x represents the average number of repeat units in an individual polymer chain. In the case of polyethylene used in many film and molded part applications, x equals about 10,000, whereas for UHMWPE, x is approximately 150,000. This extreme difference in the number of repeat units is responsible for a higher degree of chain entanglement and the distinctive properties associated with UHMWPE, including its ability to bind large quantities of inorganic filler. The molecular weight of the UHMWPE as used herein generally corresponds to a range of between about 3.1 million g/mol to about 10 million g/mol. The molecular weight of the EHMWPE as used herein generally corresponds to a range of between about 1 million g/mol to about 3.1 million g/mol.

Another distinct property is the ability of UHMWPE to resist material flow under its own weight when heated above its melting point. This phenomenon is a result of its ultrahigh molecular weight and the associated long relaxation times even at elevated temperatures. Therefore, while UHMWPE is commonly available, it is difficult to process into fiber, sheet, or membrane form. The high melt viscosity typically requires both a compatible plasticizer and a twin screw extruder for disentanglement of the polymer chains such that the resultant extruded mass can be processed into a useful form. This approach is commonly referred to as ‘gel processing’. In many cases, inorganic fillers such as silica, boehmite, alumina, or other metal oxides are blended with UHMWPE to improve wettability or other properties after extraction of the plasticizer to form a microporous film.

In the second layer that is designed for thru-plane shutdown (B layer), very high molecular weight polyethylene (VHMWPE), EHMWPE, or combinations thereof may be used. The molecular weight of the VHMWPE generally corresponds to a range of between about 500,000 g/mol to about 1 million g/mol. As set forth above, the molecular weight of the EHMWPE generally corresponds to a range of between about 1 million g/mol to about 3.1 million g/mol. This layer (B layer) may also contain a blend of different molecular weights or even small quantities of other polyolefins (e.g., polypropylene) to impact mechanical properties and the shutdown characteristics of the multilayer, microporous film

In a first embodiment of the invention, individual layers are extruded and then laminated to form a plasticizer-filled, multilayer film that is then subsequently extracted, dried, and annealed to form a multilayer, microporous membrane. In one case, one or more first layer (A layer) comprising UHMWPE, EHMWPE, or both, an inorganic filler, and a plasticizer (e.g., mineral oil) are extruded to form a homogeneous, cohesive mass. The mass is processed using blown film, cast film or calendering methods to give an inorganic-filled, plasticizer-filled sheet of reasonable thickness (about 100 um to about 1000 um). A second layer (B layer) including plasticizer and VHMWPE, EHMWPE, or both, are extruded into a separate oil-filled sheet having a thickness of about 100 um to about 1000 um. In some cases, the oil filled sheets are biaxially stretched and then laminated with heat and pressure to form a plasticizer-filled, multilayer film. For instance, the oil filled sheets (A and B layers) can be laminated at a temperature of between about 80 and about 120° C., such as between about 90 and about 110° C., and at a pressure of between about 250 psi about 2500 psi, such as between about 500 psi and about 2000 psi. In another case, the as-extruded sheets are first laminated together and next the plasticizer-filled, multilayer film is then subjected to biaxial orientation. In a third case, the inorganic-filled layer (A layer) is biaxially oriented and then extracted, dried, and annealed to form a highly filled microporous membrane in roll form. The latter can then be laminated to a biaxially oriented, plasticizer-filled, VHMWPE sheet (or a B layer). After lamination, the plasticizer is then extracted from the VHMWPE layer (or the B layer) with a solvent that is subsequently evaporated to form the microporous, multilayer polyolefin film. Further, in each instance, the first layer (A layer) and the second layer (B layer) in the resulting microporous, multilayer polyolefin membrane are cohesively bonded together. In doing so, the polyethylene chains of the first layer (A layer) and second layer (B layer) are entangled, intertwined and/or interlocked at the interface(s) between the layers such that additional binders and/or adhesive agents are not required. In some embodiments, the resulting microporous, multilayer polyolefin membrane comprises an A/B arrangement comprising two layers. In other embodiments, the resulting microporous, multilayer polyolefin membrane comprises an A/B/A arrangement comprising three layers.

In another embodiment of the invention, the inorganic-filled, first layer (A layer) or layers are coextruded with the second layer (B layer) so that they exit the die gap and form a plasticizer-filled monolithic sheet having a thickness of about 200 um to about 2000 um. For instance, the first and second layers can be coextruded at a temperature of between about 175° C. and about 250° C. The term monolithic can be used to describe the sheet because the first layer (A layer) and second layer (B layer) form a single, unitary sheet in which the individual layers are cohesively bonded together. In some embodiments, coextruded sheet comprises an A/B arrangement comprising two layers. In other embodiments, coextruded sheet comprises an A/B/A arrangement comprising three layers. The plasticizer-filled sheet is then biaxially oriented and the plasticizer is extracted with a solvent. Upon evaporation of the solvent, a microporous, multilayer polyolefin membrane is formed. The latter can undergo further stretching and/or annealing prior to winding. An advantage of the co-extrusion approach is that the first layer (A layer) and second layer (B layer) are intimately or cohesively bonded together as they exit the die. In doing so, the polyethylene chains of the first layer (A layer) and second layer (B layer) are entangled, intertwined and/or interlocked at the interface(s) between the layers such that additional binders and/or adhesive agents are not required.

The resultant multilayer, microporous, freestanding polyolefin membrane (from either embodiment) can be wound or stacked in a package to separate the electrodes in an energy storage device, for example, a battery, capacitor, supercapacitor, or fuel cell. The resultant microporous polyolefin membrane has an average thickness of about 3 μm to about 25 μm. The average pore size for the microporous membranes is generally less than about 1 micrometer (e.g., 0.1 to 0.3 microns as measured by mercury porosimetry). Membrane pores can be filled with electrolyte both in the inorganic-filled first layer (A layer) and the second layer (B layer). The inorganic-filled first layer (A layer) can further enhance the wettability with the electrolyte. Such membranes are beneficial to the manufacture of energy storage devices, particularly since they combine excellent in-plane dimensional stability with thru-plane shutdown characteristics at temperatures that exceed the melting point of the polymer matrix of either or any layer of the multilayer membrane.

In some embodiments, the resultant multilayer, microporous, freestanding polyolefin membrane exhibits in-plane areal shrinkage of less than 20%, less than 10%, or less than 5% at temperatures above the melting point of the polymer matrix. In some embodiments, the resultant multilayer, microporous, freestanding polyolefin membrane exhibits a decrease in thru-plane air permeability as evidenced by a 5 times or greater increase in the Gurley value after exposure of the separator to temperatures above the melting point of the polymer matrix.

In yet another embodiment, if desired, the multilayer, microporous, freestanding polyolefin membrane is passed through an aqueous dispersion of a gel-forming polymer material to form an adhesive layer (C layer). A porous, surface coating (or porous adhesive layer) of controlled thickness can be formed on one or both sides using various approaches that include wire-wound rods (e.g., Mayer rods), gravure, slot-die, roll-knife, or blade coaters. The coated multilayer, microporous, freestanding polyolefin membrane is dried with a series of air knives in a heated oven.

The drying is performed at a temperature below the glass transition temperature or the melting point of the suspended polymer emulsion particles, depending upon whether they are amorphous or crystalline. As such, the shape of the suspended polymer particles does not change substantially during the drying process. Alternatively, the porous gel-forming or adhesive layers could be formed from the phase separation and drying of a solvent-polymer mixture. Examples of the gel-forming polymer materials include polyvinylidine fluoride (PVDF), polyvinylidine fluoride-co-hexafluoropropylene (PVDF-HFP) copolymers, PVDF-acrylic acid copolymers, acrylates, polyacrylate copolymers, polymethylmethacrylate copolymers, and mixtures thereof. The resultant separators can be laminated under heat and pressure to battery electrodes prior to electrolyte filling. As can be appreciated, the coated multilayer membrane can comprise various arrangements of layers, including a A/B/C arrangement, a C/A/B arrangement, a C/A/B/C arrangement, a A/B/A/C arrangement, and a C/A/B/A/C arrangement, etc.

Additional objects and advantages of this invention will be apparent from the following detailed description of preferred embodiments thereof which proceeds with reference to the accompanying drawings.

### BRIEF DESCRIPTION OF THE DRAWINGS

FIG. 1 depicts a cross-sectional schematic of a two-layer, microporous polyolefin membrane with an inorganic-filled first layer (A layer) and a second layer (B layer).

FIG. 2 depicts a cross-sectional schematic of a three-layer, microporous polyolefin membrane with a second layer (B layer) sandwiched between inorganic-filled first and third layers (A layers).

FIG. 3 depicts a cross-section of an image of an oil-filled, three-layer polyolefin sheet with a second layer (B layer) sandwiched between inorganic-filled first and third layers (A layers).

### DETAILED DESCRIPTION

The membrane used in this invention is comprised of multiple polyolefin layers, at least one of which contains inorganic particles at a loading level that provides excellent in-plane dimensional stability at temperatures that exceed the melting point of the polymer matrix. The polyolefin most preferably used in the polymer matrix of the inorganic-filled first layer (A layer) is an ultrahigh molecular weight polyethylene (UHMWPE) having a molecular weight between about 3.1 million g/mol and about 10 million g/mol, an extra high molecular weight polyethylene (EHMWPE) having a molecular weight between about 1 million g/mol and about 3.1 million g/mol, or combinations thereof. It is desirable for the polyolefin (UHMWPE, EHMWPE, or both) to be less than or equal to about 35% by weight of the inorganic-filled layer and more preferably less than or equal to about 20% by weight. In some embodiments, the polyolefin (UHMWPE, EHMWPE, or both) is less than or equal to about 10% by weight, or less than or equal to about 5% by weight of the inorganic-filled layer. The inorganic filler can include inorganic particles, which can be distributed substantially homogenously throughout the polymer matrix. Inorganic particles used as the inorganic filler can include inorganic oxides, carbonates, hydroxides, or fluorides, such as at least one of alumina, silica, zirconia, titania, mica, boehmite, magnesia, magnesium hydroxide, calcium carbonate, hydrotalcites, boron oxides, or mixtures thereof. The inorganic filler may include colloidal or fumed inorganic particles. The inorganic filler can be from about 65% to about 95% by weight of the inorganic-filled layer (A layer).

Very high molecular weight polyethylene (VHMWPE) with a molecular weight of between about 500,000 g/mol to about 1 million g/mol, EHMWPE with a molecular weight of between about 1 million g/mol to about 3.1 million g/mol, or a combination thereof is preferred for the polymer matrix of the second layer (B layer). Representative polymers include VH035 from KPIC (Korea), GUR 4102 from Celanese (USA), and UH650 from Asahi-Kasei (Japan).

The plasticizer employed in the present invention is a nonevaporative solvent for the polymer, and is preferably a liquid at room temperature. The plasticizer has little or no solvating effect on the polymer at room temperature, it performs its solvating action at temperatures at or above the softening temperature of the polymer. For UHMWPE, the solvating temperature would be above about 180° C., and preferably in the range of between about 200° C. and about 225° C. It is preferred to use a processing oil, such as a paraffinic oil, naphthenic oil, aromatic oil, or a mixture of two or more such oils. Examples of suitable processing oils include: Risella 430X by Shell Oil Company; and Hydrocal™ 800 by Calumet Specialty Products; and Nytex 820 by Nynas Inc.

The polymer/oil mixture for each layer is extruded through a sheet die or annular die, and then it is biaxially-oriented to form a thin, oil-filled film. Any solvent that is compatible with the oil can be used for the extraction step, provided it has a boiling point that makes it practical to separate the solvent from the plasticizer by distillation. Such solvents include 1,1,2 trichloroethylene, perchloroethylene, 1,2-dichloroethane, 1,1,1-trichloroethane, 1,1,2-trichloroethane, methylene chloride, hexane, heptane, decane, and toluene. In some cases, it is desirable to select the processing oil such that any residual oil in the polymer sheet after extraction is electrochemically inactive.

FIG. 1 shows a cross-sectional schematic of a two-layer, microporous polyolefin membrane 100 with an inorganic-filled first layer 104 (first layer) and a second layer 102 (B layer). As shown, the microporous, multilayer polyolefin membrane 100 comprises an A/B arrangement comprising two layers.

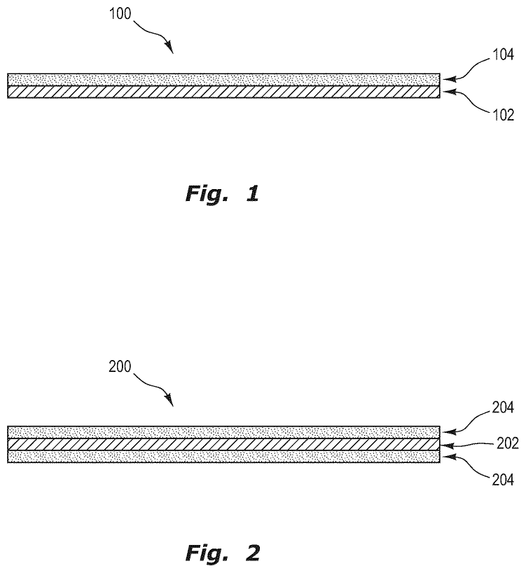

In FIG. 2, a three-layer microporous polyolefin membrane 200 is shown in which the second layer 202 (B layer) is sandwiched between two inorganic-filled layers 204 (A layers). As shown, the microporous, multilayer polyolefin membrane 200 comprises an A/B/A arrangement comprising three layers.

As previously discussed, the inorganic-filled layers (A layers) and second layer (B layer) can be intimately or cohesively bonded together using approaches such as lamination or co-extrusion. In doing so, the polyethylene chains of the A layer and B layer are entangled, intertwined and/or interlocked at the interface(s) between the layers such that additional binders and/or adhesive agents are not required. In some cases, one of the layers can be pre-extracted prior to bonding to the other plasticizer-filled layer. Some examples are as follows:

### Example 1

A naphthenic process oil, precipitated silica, and UHMWPE were fed into a twin screw extruder and processed at ~225° C. to form an approximately 350 um thick oil-filled sheet. The resultant sheet was then biaxially stretched at 4.5× in the machine-direction (MD) and 4.0× in the transverse-direction (TD) at elevated temperature to produce a wound roll of reduced thickness. The roll was then unwound and passed through a trichloroethylene extraction bath, followed by evaporation of the solvent, drying, and annealing to form a microporous membrane. The microporous membrane contained 67 wt % silica and 33 wt % UHMWPE as measured by thermogravimetric analysis. The membrane had a thickness of ~22 μm and a Gurley air permeability of 41 seconds/100 cc air.

The thermal shrinkage of the membrane was measured after exposure in an oven to the following conditions set forth in Table 1:

TABLE 1

| | | Gurley Air | | |
|---|---|---|---|---|
| | Thickness | Permeability | | |
| | (um) | (sec/100 cc) | MD % | TD % |
| Roll Extracted | 21.6 | 41 | | |
| 30 min @ 130 C. | 24.3 | 35.7 | 13.7 | 2.3 |
| 5 min @ 180 C. | 19.7 | 9 | 13.7 | 1.1 |

### Example 2

A 70/30 ratio of paraffinic process oil and VHMWPE (VH035; KPIC) were fed into a twin screw extruder and processed at ~225° C. to form a 750 um thick oil-filled sheet. The resultant sheet was then biaxially stretched at 7.0× in the machine-direction (MD) and 6.0× in the transverse-direction (TD) at ~15° C. to form a ~20 um thick sheet that was wound into roll form.

A 100 mm×100 mm piece of oil filled sheet was held with clamps in a metal frame that supported all 4 sides of the sheet. The sample was then extracted in trichloroethylene, and the frame was then placed in a circulating oven at 60° C. to dry and anneal the resultant microporous membrane. The membrane had −21 um thickness and a Gurley air permeability of 280 secs/100 cc air.

When the membrane was subjected to heating in an oven for 30 mins at 130° C., it shrank into an irregularly-shaped polyethylene mass with no porosity, as set forth in the following Table 2:

TABLE 2

| | | Gurley Air | | |
|---|---|---|---|---|
| | Thickness | Permeability | | |
| | (um) | (sec/100 cc) | MD % | TD % |
| Frame Extracted | 21 | 280 | | |
| 30 min @ 130 C. | Sample shrunk up to a small postage stamp size mass | | | |
| 5 min @ 180 C. | n/a | n/a | n/a | n/a |

### Example 3

A tri-layer film was formed from the lamination at 105° C. and 1500 psi of the silica-filled membrane of Example 1 to each side of the oil-filled sheet of Example 2. A 100 mm×100 mm piece of the tri-layer film was held with clamps in a metal frame that supported all 4 sides of the sheet. The sample was then extracted in trichloroethylene, and the frame was then placed in a circulating oven at 60° C. to dry and anneal the resultant tri-layer, microporous membrane. The membrane had ~49 um thickness and a Gurley air permeability of 1759 sec/100 cc air.

The thermal shrinkage of the tri-layer membrane was measured after exposure in an oven to the following conditions set forth in Table 3:

TABLE 3

| | | Gurley Air | | |
|---|---|---|---|---|
| | Thickness | Permeability | | |
| | (um) | (sec/100 cc) | MD % | TD % |
| Frame Extracted | 49.2 | 1759 | | |
| 30 min @ 130 C. | 39 | 12,320 | 7.7 | 9.1 |
| 5 min @ 180 C. | 39.5 | 12,839 | 9.4 | 9.1 |

The above results show that the silica-filled layers restricted in-plane shrinkage of the tri-layer membrane while a dramatic increase in Gurley air permeability was observed, indicating thru-plane shutdown of the pore structure in the B layer.

### Example 4

A 70/30 ratio of paraffinic process oil and VHMWPE (VH035; KPIC) was fed into a twin screw extruder and processed into a 650 μm thick oil-filled sheet, designated as “B”. In a separate extruder, a 70/25/5 ratio of paraffinic process oil, boehmite, and UHMWPE was fed into a twin screw extruder and processed into a 200 μm thick oil-filled sheet, designated as “A”. The sheets were laminated at 105° C. and 500 psi in an A/B/A arrangement and then placed into a Karo Model 6 biaxial stretch table top unit. The stack was stretched at 8× in the machine-direction (MD) and 8× in the transverse-direction at ~115° C. The biaxially stretched, tri-layer sheet was held with clamps in a metal frame that supports all 4 sides of the sheet. The sample was then extracted in trichloroethylene, and the frame was then placed in a circulating oven at 60° C. to dry and anneal the resultant tri-layer, microporous membrane. The layers were intimately and cohesively bonded together such that the boehmite-containing layers could not be peeled away. The tri-layer microporous membrane had a thickness of ~13 μm and a Gurley air permeability value of ~200 sec/100 cc air.

### Example 5

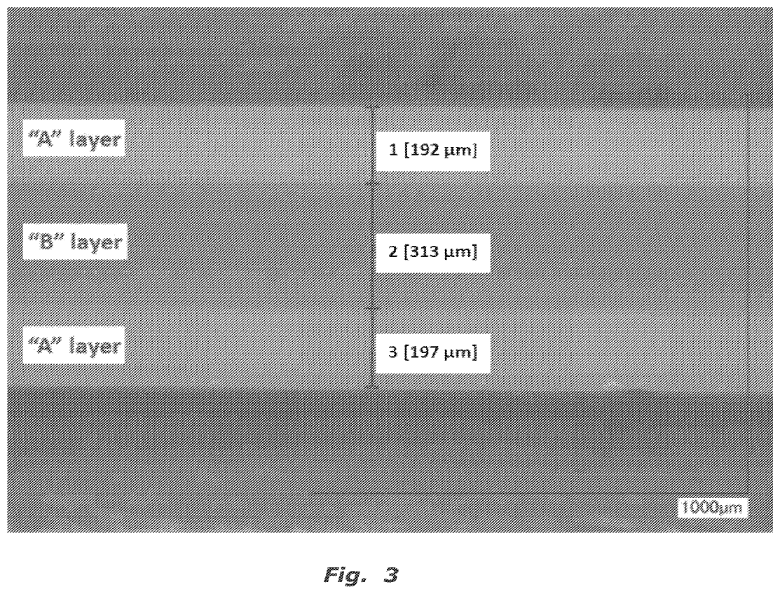

A pair of twin screw extruders were connected to an A/B/A trilayer die. A 70/30 ratio of paraffinic process oil and VHMWPE (VH035; KPIC) mixture was melt processed in a twin screw extruder #1 at 180° C. and fed to the center layer of the tri-layer die having a 500 pm gap as the “B” layer. In twin screw extruder #2, a 40/54/6 ratio of paraffinic process oil, boehmite, and EHMWPE (VH150U; KPIC) mixture was melt processed at 180° C. and then split into two melt streams feeding the top and bottom layers of the tri-layer die as the “A” layers. The gap in the top and bottom layers of the tri-layer die was set at 250 μm. The three oil-filled layers merged in the lip of the tri-layer die with the center “B” layer sandwiched in between the top and bottom “A” layer. The temperature of the tri-layer die was set at 175° C., and the gap at the lip of the die was set at approximately 750 μm. A cross-section of the A/B/A tri-layer oil-filled sheet is depicted in FIG. 3. The oil-filled A/B/A sheet was cut into a 100 mm×100 mm sample and then placed into a Karo Model 6 biaxial stretch table top unit. The stack was stretched at 8× in the machine-direction (MD) and 8× in the transverse-direction at ~115° C. The biaxially stretched, tri-layer sheet was held with clamps in a metal frame that supports all 4 sides of the sheet. The sample was then extracted in trichloroethylene, and the frame was then placed in a circulating oven at 60° C. to dry and anneal the resultant tri-layer, microporous membrane. The layers were intimately and cohesively bonded together. The extruded tri-layer microporous membrane has a thickness of ~13 um and a Gurley air permeability value of ~200 sec/100 cc air.

While various aspects and embodiments have been disclosed herein, other aspects and embodiments are contemplated. The various aspects and embodiments disclosed herein are for purposes of illustration and are not intended to be limiting.

References to approximations are made throughout this specification, such as by use of the terms “about” or “approximately.” For each such reference, it is to be understood that, in some embodiments, the value, feature, or characteristic may be specified without approximation. For example, where qualifiers such as “about,” “substantially,” and “generally” are used, these terms include within their scope the qualified words in the absence of their qualifiers. Further, all ranges include both endpoints.

The claims following this written disclosure are hereby expressly incorporated into the present written disclosure, with each claim standing on its own as a separate embodiment. This disclosure includes all permutations of the independent claims with their dependent claims. Moreover, additional embodiments capable of derivation from the independent and dependent claims that follow are also expressly incorporated into the present written description.

Without further elaboration, it is believed that one skilled in the art can use the preceding description to utilize the invention to its fullest extent. The claims and embodiments disclosed herein are to be construed as merely illustrative and exemplary, and not a limitation of the scope of the present disclosure in any way. It will be apparent to those having ordinary skill in the art, with the aid of the present disclosure, that changes may be made to the details of the above-described embodiments without departing from the underlying principles of the disclosure herein. In other words, various modifications and improvements of the embodiments specifically disclosed in the description above are within the scope of the appended claims. The scope of the invention is therefore defined by the following claims and their equivalents.

1. A multilayer freestanding, microporous polyolefin film, comprising:
a first layer including inorganic particles and a polymer matrix comprising ultrahigh molecular weight polyethylene (UHMWPE), extra high molecular weight polyethylene (EHMWPE), or combinations thereof; and
a second layer including a polymer matrix comprising very high molecular weight polyethylene (VHMWPE), extra high molecular weight polyethylene (EHMWPE), or combinations thereof,
wherein the first layer and second layer are cohesively bonded together, and wherein in-plane shrinkage of the multilayer freestanding, microporous polyolefin film is restricted while thru-plane permeability is decreased above the melting point of the polymer matrix of either the first or second layer.

2. The multilayer freestanding, microporous polyolefin film according to claim 1, wherein the first layer comprises at least 65% by weight inorganic particles.

3-4. (canceled)

5. The multilayer freestanding, microporous polyolefin film according to claim 1, further comprising a third layer including an inorganic particles and a polymer matrix comprising ultrahigh molecular weight polyethylene (UHMWPE), extra high molecular weight polyethylene (EHMWPE), or combinations thereof, wherein the second layer is sandwiched between the first layer and the third layer, and wherein the second layer is cohesively bonded to the first layer and the third layer at adjoining interfaces.

6. The multilayer freestanding, microporous polyolefin film according to claim 1, wherein the first layer and the second layer are cohesively bonded together without bonding or adhesive agents.

7. The multilayer freestanding, microporous polyolefin film according to claim 1, wherein the polyethylene chains of the first the second layer are entangled at the interface between the layers.

8. The multilayer freestanding, microporous polyolefin film according to claim 1, further comprising a porous adhesive layer applied to the first layer.

9. The multilayer freestanding, microporous polyolefin film according to claim 8, wherein the porous adhesive layer includes polyvinylidine fluoride (PVDF), polyvinylidine fluoride-co-hexafluoropropylene (PVDF-HFP) copolymers, PVDF-acrylic acid copolymers, acrylates, polyacrylate copolymers, polymethylmethacrylate copolymers, or mixtures thereof.

10. The multilayer freestanding, microporous polyolefin film according to claim 5, further comprising a porous adhesive layer applied to the third layer.

11. The multilayer freestanding, microporous polyolefin film according to claim 1, wherein the first layer and second layer are laminated together.

12. The multilayer freestanding, microporous polyolefin film according to claim 1, wherein the first layer and second layer are coextruded to form a monolithic sheet.

13. The multilayer freestanding, microporous polyolefin film according to claim 1, wherein the multilayer freestanding, microporous polyolefin film comprises a thickness of between about 3 μm to about 25 μm.

14. The multilayer freestanding, microporous polyolefin film according to claim 1, wherein the multilayer freestanding, microporous polyolefin film comprises pores having an average pore size of less than about 1 micrometer.

15. The multilayer freestanding, microporous polyolefin film according to claim 1, wherein the inorganic particles comprise inorganic oxides, carbonates, hydroxides, fluorides, or mixtures thereof.

16. The multilayer freestanding, microporous polyolefin film according to claim 1, wherein the VHMWPE comprises a molecular weight of between about 500,000 g/mol and about 1 million g/mol.

17. The multilayer freestanding, microporous polyolefin film according to claim 1, wherein the EHMWPE comprises a molecular weight of between about 1 million g/mol and about 3.1 million g/mol.

18. The multilayer freestanding, microporous polyolefin film according to claim 1, wherein the UHMWPE comprises a molecular weight of between about 3.1 million g/mol and about 10 million g/mol.

19. An energy storage device comprising the multilayer freestanding, microporous polyolefin film according to claim 1.

20. A method of making a multilayer freestanding, microporous polyolefin film, comprising:
forming a first layer including inorganic particles and a polymer matrix comprising ultrahigh molecular weight polyethylene (UHMWPE), extra high molecular weight polyethylene (EHMWPE), or combinations thereof; and
forming a second layer including a polymer matrix comprising very high molecular weight polyethylene (VHMWPE), extra high molecular weight polyethylene (EHMWPE), or combinations thereof,
cohesively bonding together the first layer and the second layer, without bonding or adhesive agents, wherein in-plane shrinkage of the multilayer freestanding, microporous polyolefin film is restricted while thru-plane permeability is decreased above the melting point of the polymer matrix of either the first or second layer.

21. The method of claim 20, wherein cohesively bonding together the first layer and the second layer comprises coextruding the first layer and the second layer to form a monolithic sheet.

22. The method of claim 20, wherein cohesively bonding together the first layer and the second layer comprises laminating the first layer and the second layer.
